(19) United States
(12) Patent Application Publication
(10) Pub. No.: US 2020/0104291 A1
(43) Pub. Date: Apr. 2, 2020

(54) PERFORMING AN ACTION WITHIN A MACHINE-GENERATED BIG DATA ENVIRONMENT

(71) Applicant: NATIONWIDE MUTUAL INSURANCE COMPANY, Columbus, OH (US)

(72) Inventor: John Villacres, Columbus, OH (US)

(21) Appl. No.: 16/585,644

(22) Filed: Sep. 27, 2019

Related U.S. Application Data
(60) Provisional application No. 62/738,007, filed on Sep. 28, 2018.

(51) Int. Cl. G06F 16/23; G06F 16/28; G06F 16/2455

(52) U.S. Cl. CPC G06F 16/2358; G06F 16/24565; G06F 16/283

(57) ABSTRACT

A process for performing an action within a big data environment comprises monitoring, with a first alert, a data repository of machine-generated logs for a first designated change in the machine-generated logs. Based on the first designated change in the data repository, a first search is performed within the data repository. A first object, which may include parameters to be passed to a second alert, is created and written to the data repository based on a result of the first search. The data repository is monitored with the second alert for a second designated change in the machine-generated logs, and the second designated change in the machine-generated logs corresponds to the first object. The data repository is searched a second time based on the second designated change in the machine-generated logs and possibly the parameters passed from the first alert. Based on the second search, a predetermined action is performed.

### CROSS REFERENCE TO RELATED APPLICATIONS

This application claims the benefit of U.S. Provisional Patent Application Ser. No. 62/738,007, filed Sep. 28, 2018, entitled “PERFORMING AN ACTION WITHIN A MACHINE-GENERATED BIG DATA ENVIRONMENT”, the disclosure of which is hereby incorporated by reference.

### BACKGROUND

Various aspects of the present invention relate generally to an improvement in a big-data environment, and specifically to the technological field of performing actions within a big-data environment.

A big-data environment includes extremely large data sets that are analyzed to reveal patterns, trends, associations, etc. The data sets are sometimes consolidated into a data repository, and a big-data monitoring tool monitors the data repository. A user can set up alerts that indicate when a specific change occurs in the data sets.

### BRIEF SUMMARY

According to aspects of the present invention, a process for performing an action within a machine-generated big data environment including a repository comprises serially executing alerts within the big data environment. When an alert is triggered, an action is performed and an object with parameters for a next alert is created and stored in the data repository. The next alert triggers when the object is written to the data repository. Thus, alerts may be nested within the big data environment to simulate a program or script.

According to aspects of the present invention, a process for performing an action within a big data environment comprises monitoring, with a first alert, a data repository of machine-generated logs for a first designated change in the machine-generated logs. Based on the first designated change in the data repository, a first search is performed within the data repository. A first object, which may include parameters to be passed to a second alert, is created and written to the data repository based on a result of the first search. The data repository is monitored with the second alert for a second designated change in the machine-generated logs, and the second designated change in the machine-generated logs corresponds to the first object. The data repository is searched a second time based on the second designated change in the machine-generated logs and possibly the parameters passed from the first alert. Based on the second search, a predetermined action is performed.

According to further aspects of the present disclosure, process for verifying a device on a network using the process for performing an action within a big-data environment comprises: consolidating multiple system logs into a known-devices system log in a data repository and monitoring the data repository for an event that signifies a new device has accessed a network. If the event that signifies a new device has accessed a network occurs, then the known-devices system log is searched to determine if an identity of the new device is present in the known-devices system log. If the identity of the new device is not present in the known-devices system log, then a locally-not-found object (including the identity of the new device) is written to the data repository. The data repository is monitored for the locally-not-found object, and if it is added to the data repository, then the identity of the new device from the locally-not-found object is retrieved. Also, if locally-not-found object is added to the data repository, then an external script that uses an application programming interface (API) of an external application is invoked to determine if the identity of the new device is known to the external application. If the identity of the new device is not known to the external application, then an externally-not-known object is written to the data repository. The data repository is monitored for the externally-not-known object, and if it is added to the data repository, a predetermined action is performed.

### BRIEF DESCRIPTION OF THE SEVERAL VIEWS OF THE DRAWINGS

FIG. 1 is a diagram illustrating a networking system, according to various aspects of the present disclosure;

FIG. 2 is a flow chart illustrating a process for performing an action within a machine-generated big-data environment, according to various aspects of the present disclosure;

FIG. 3 is a block diagram of a big-data environment for an example illustration of the process of FIG. 2, according to various aspects of the present disclosure;

FIG. 4 is a flow chart of the example illustration of the process of FIG. 2 illustrating three alerts, according to various aspects of the present disclosure; and

FIG. 5 is a block diagram of a computer system having a computer readable storage medium for implementing functions according to various aspects of the present invention as described in greater detail herein.

### DETAILED DESCRIPTION

Aspects of the present disclosure are directed toward performing an action in a big-data environment of machine-generated logs, which are next to impossible for a human to comprehend. Using nested alerts, a user may provide functionality not previously offered in big-data environment monitoring tools. The improvements described herein utilize unconventional elements such as embedding alerts to expand capabilities of the big-data monitoring tools. Embedding alerts within a big-data monitoring tool includes monitoring data in a database for a change in the database (e.g., a change in an existing entry, a new entry, a deleted entry, etc.). Once the change occurs, depending on conditions within the database, an object is written to the database. The embedded alert monitors for the object to be written, and once that object is detected, an action is performed. Thus, the embedded alerts can be used to mimic a program.

This process provides an advantage over previous solutions within the big-data environment. For example, in previous solutions once an alert occurs, a program external to the big-data monitoring tool may be invoked outside the big-data monitoring tool. The external program is written via a scripting language. Thus, a user must know the scripting language in order to write the program. Further, the external program would require many lines of code, so the time required to create the external program is quite long, even if the user knows the scripting language. Moreover, the amount of time to run the external program may be longer than running the embedded alerts. Therefore, the solutions provided herein provide advantages over present solutions.

Networking Overview

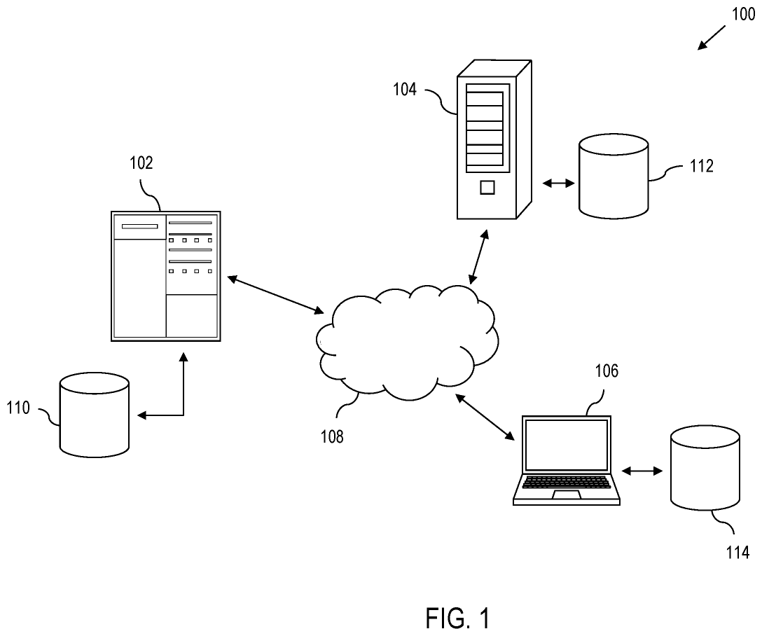

Referring to drawings and in particular FIG. 1, a network system 100 is illustrated according to aspects of the present disclosure herein. Generally, a processing device designated as a first machine 102 communicates with one or more remote processing devices, e.g., a second machine 104 and a third machine 106, across a network 108. The second machine 104 and third machine 106 are illustrated solely for purposes of simplified explanation. In practice, one or more remote devices may communicate with the first machine 102. The first machine 102 may comprise a mainframe computer, server computer, or other processing device that is capable of responding to data transfer requests, as will be described in greater detail herein. In this regard, the first machine 102 has access to storage 110, e.g., any form of storage, including disk(s), network addressed storage (NAS), file server(s), a cloud-based storage or other structure where data can be retrieved.

The second machine 104 and third machine 106 may each comprise any processing device that is capable of communicating over the network 108 to request and/or receive data from the first machine 102. For instance, typical processing devices include server computers, personal computers, notebook computers, and tablets. The second machine 104 or third machine 106 may also comprise by way of example, transactional systems, purpose-driven appliances, cellular devices including smart telephones, and special purpose computing devices.

For purposes of discussion herein, the second machine 104 has access to storage 112 where data received from the first machine 102 is to be stored. Likewise, the third machine 106 has access to storage 114 where data received from the first machine 102 is to be stored. In the context of a big-data environment, the data may be stored in the storage 112, 114 and accessed by any of the machines.

The network 108 provides communication links between the various processing devices, e.g., the first machine 102, the second machine 104, and the third machine 106. Accordingly, the network 108 may be supported by networking components such as routers, switches, hubs, firewalls, network interfaces, wired or wireless communication links and corresponding interconnections, cellular stations and corresponding cellular conversion technologies, e.g., to convert between cellular and TCP/IP, etc. Such devices are not shown for purposes of clarity. Moreover, the network 108 may comprise connections using one or more intranets, extranets, local area networks (LAN), wide area networks (WAN), wireless networks (WIFI), the Internet, including the world wide web, a cloud, and/or other arrangements for enabling communication between the processing devices, in either real time or otherwise, e.g., via time shifting, batch processing, etc.

The network system 100 is shown by way of illustration, and not by way of limitation, as a computing environment in which various aspects of the present disclosure may be practiced. Other configurations may alternatively be implemented. All of the devices discussed above in reference to the network (e.g., machines, routers, switches, hubs, etc.) are entities within the network.

Nested Alerts

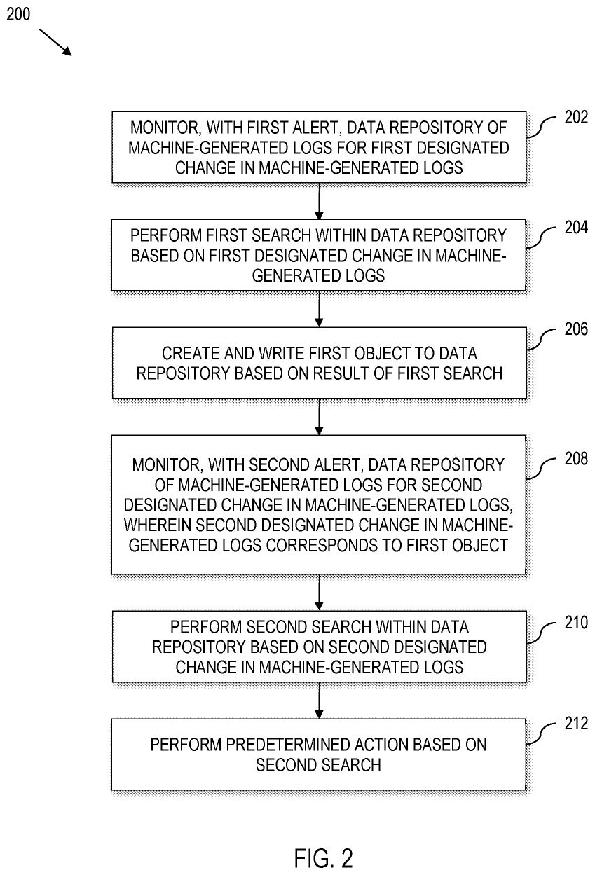

FIG. 2 is a flow chart illustrating a process 200 for performing an action within a machine-generated big-data environment. At 202, using a first alert, a data repository in a big-data environment of machine-generated logs is monitored for a first designated change in the machine-generated logs. For example, a user uses a big-data monitoring tool (e.g., Splunk, LogRhythm, etc.) to set an alert indicating when a new item is added to the database. Splunk is a registered trademark of Splunk Inc. a Delaware corporation located in San Francisco, Calif. 94107. LogRhythm is a registered trademark of LogRhythm, Inc. a Delaware corporation located in Boulder, Colo. 80301.

The data repository may be any big-data repository, whether it is structured or unstructured. The designated change may be an addition of a log, a change in a log, a removal of a log, etc. For example, in an environment that keeps track of an inventory at a warehouse, when items related to a certain SKU (stock keeping unit) become low (e.g., are outside a threshold), then an alert fires letting the user know that the item associates with the SKU is low. As another example, in an environment associated with a security environment of a network, if a device logs onto the network and is added to a list of devices on the network, an alert will fire letting the user know a new device has logged onto the network.

At 204, a first search is performed within the data repository based on the first designated change in the machine-generated logs. For example, if the first alert is concerned with determining if a new device is added to the network (as discussed above), then when a device is detected, the search can be to determine if the device is already registered on the network.

At 206, a first object is created and written to the data repository based on the first search. In some embodiments, the object includes a parameter for a second search. For example, using the example above about the device being added to the network, the object written may include a name of the device, a time the device logged on, an indication of how many attempts the device had to log on, etc., or combinations thereof. Moreover, the object may be in any desired format (e.g., JavaScript Object Notation (JSON), Python, etc.).

The created object may be written to a selected subset of the machine-generated logs in the database. For example, if the first alert is monitoring a first subset of machine-generated logs in the data repository, then the object can be written to that subset of machine generated logs in the data repository or to a different subset of machine-generated logs in the data repository. By writing the object to the machine-generated logs data repository, the objects are then available for future searching and display. Then, when a user search of the repository reveals the object, the object may be displayed for the user. The object may also be displayed for other reasons as well.

At 208, a second alert is used to monitor the data repository of machine-generated logs for a second designated change in the machine-generated logs, and the second designated change in the machine-generated logs corresponds to the first object. For example, the second designated change may be the object being written to the data repository. If the object is present (and previously was not present), then the second alert goes active.

At 210, a second search is performed within the data repository based on the second designated change in the machine-generated logs, similar to the first search above. However, the second search may use the parameter that may have been included in the object to supplement the second search. For example, if the object includes a device name as a parameter, then the second search can search a subset of the data logs for the device name. In such a fashion, the object can be used to pass parameters between the nested alerts (i.e., the second alert is nested in the first alert, and a parameter is passed from the first alert to the second alert through the object).

At 212, a predetermined action is performed based on the second search. Similar to the second search, the predetermined action may use the parameter passed through the object as a part of the predetermined action. For example, the predetermined action may be to write a second object with a second parameter and may also include the parameter from the first object. As another example of a predetermined action, an internal or external script may be launched. The internal or external script is written in a scripting language. For example, the internal or external script may make a call to an external program through an application programming interface (API) to retrieve data from the external program.

More than one alert may be nested as well. For example, two alerts may be nested in parallel in a first alert. As another example, a third alert may be nest in a second alert that is nested in a first alert (i.e., alerts nested serially). As mentioned above, parameters are passed through the serially nested alerts by writing objects that include one or more parameters. The alerts mentioned herein are not a scripting language. Instead, they are alerts that are set up in a big-data monitoring tool, as mentioned above. Therefore, the user of the big-data monitoring tool does not need to know a scripting language to provide functionality not normally associated within the big-data monitoring tool. Thus, the method 200 above is an improvement in a computer-related technology.

Example Nested Alerts

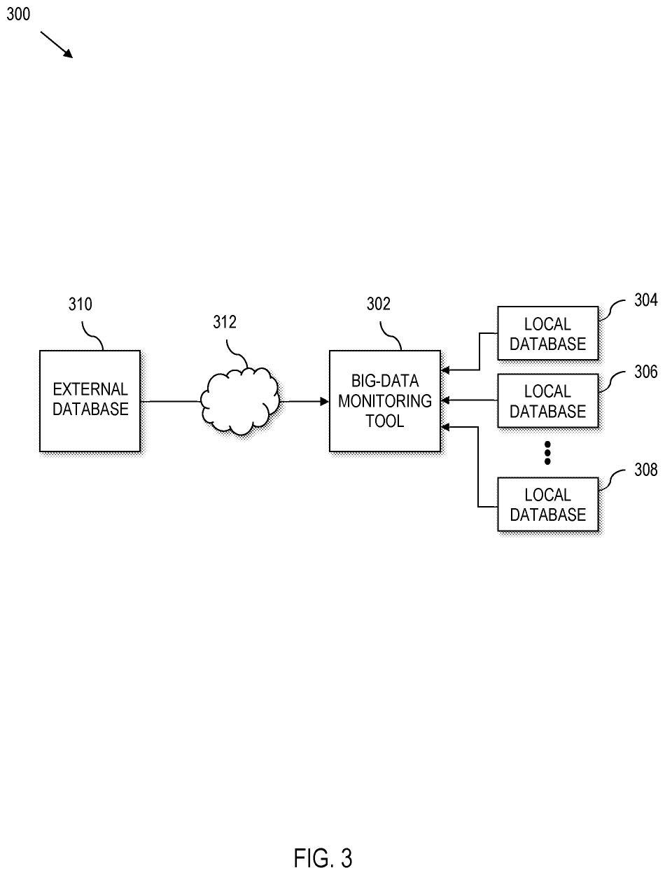

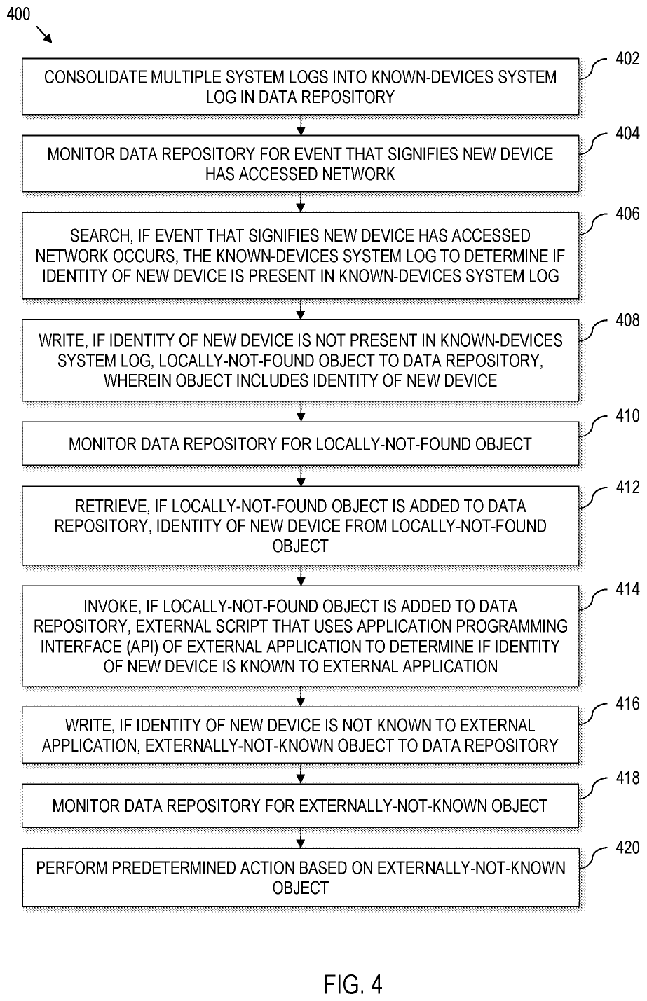

FIGS. 3-4 illustrate an example of using the nested alerts described above to perform an action in a big-data environment. While the example of FIGS. 3-4 is for registering a new device to a network, the method 200 of FIG. 2 can be used for any action desired in a big-data environment.

FIG. 3 illustrates a big-data environment 300, where a big-data monitoring tool 302 is accessed by a processor locally, remotely, or both. Thus, data required to perform an action may be spread out over several local and remote databases. The big-data monitoring tool 302 has access to local databases (e.g., 304, 306, 308) and an external database 310. Each of the databases are accessed over a network, but the external database is accessed over an external network 312.

FIG. 4 is a flow chart illustrating a method 400 for implementing the example of verifying/registering a device on a network. At 402, system logs from local databases are consolidated on a data repository. For example, the local databases (304, 306, 308 of FIG. 3) include system logs regarding devices that are verified on a network. The system logs are consolidated into a known-devices system log on a large data repository accessed by the big-data monitoring tool.

At 404, the data repository is monitored for an event that signifies a new device has accessed a network (similar to 202 of the process 200 of FIG. 2). The data repository includes a list of devices that are currently accessing the network. When a device accesses the network, an entry is added to the list signifying that the device is added to the network, and the entry includes an identification of the device. As discussed above, an alert looks for a device to be added to the list, and when a device is added, the alert fires. In this example, a device with an identification of ID_New is added to the devices on the network.

At 406, if the event that signifies a new device has accessed a network occurs, then the known-devices system log is searched to determine if an identity of the new device is present in the known-devices system log (similar to 204 of the process 200 of FIG. 2). In the current example, the list of known devices includes: Known_1, Known_2, Known_3, and Known_4. Thus, the added device identification, ID_New, is not present in the known-devices system log. There may be more than one search to determine if the device is present in multiple known-devices system logs if not all of the known device identifications are consolidated into one consolidated known-devices system log. However, if the device identification is found in the known-devices system log, then the process would end, because the device has previously been verified.

At 408, if the identity of the new device is not present in the known-devices system log, then a locally-not-found object is added to the data repository, wherein the object includes the identity of the new device (similar to 206 of the process 200 of FIG. 2). Therefore, in the present example, a locally-not-found object with a parameter that includes the added device identification, ID_New, is written to the data repository as a new item.

At 410, the data repository is monitored for the locally-not-found object (similar to 208 of the process 200 of FIG. 2). In the present example, the data repository is monitored for the locally-not-found object, and if the locally-not-found object is present, then an alert fires.

At 412, if the locally-not-found object is present in the data repository, then the identity of the new device is retrieved. In the present example, the identity of the new device, ID_New, was written as a parameter in the locally-not-found object (similar to 210 of the process 200 of FIG. 2). Therefore, the device identification is retrieved through the locally-not-found object.

At 414, if the locally-not-found object is not present in the data repository, then a script that uses an application programming interface (API) of an external application is invoked to determine if the identity of the new device is known to the external application (similar to 212 of the process 200 of FIG. 2. In the present example, the new device identification, ID_New, is plugged into an external script that calls an external application that searches an external database for ID_New. The external application returns a result of whether ID_New is found externally to the external script. The external script then returns the result of whether ID_New is found externally and stops executing if ID_New is found. Thus, the external script is completed. In the present example, the device is not found externally.

At 416, if the identity of the new device is not known to the external application, then an externally-not-known object is written to the data repository with a parameter that includes the new device identification. In the present example, the new device is not found externally, so an externally-not-known object is written to the data repository, where ID_New is a parameter of the externally-not-known object. However, if the device identification had been found externally, then the process 400 would end, because the device was previously verified but not added locally.

At 418, the data repository is monitored for the externally-not-known object. In the present example, the data repository is monitored for the externally-not-known object, and if the externally-not-known object is present, then an alert fires.

At 420, a predetermined action is performed if the externally-not-known object is present. For example, a security team may be alerted (a parameter of the externally-not-known object may include a location of the new device), a work order may be created to vet the new device, an app may be pushed to the new device to detect malware, etc. or combinations thereof.

The preceding example illustrates three alerts, where two of the alerts are nested serially in the first alert. Information needed for actions performed in response to the alerts are passed as parameters in objects written to the data repository. As such, a user of the big-data monitoring tool does not need to know a scripting language to provide functionality not normally associated within the big-data monitoring tool.

Miscellaneous

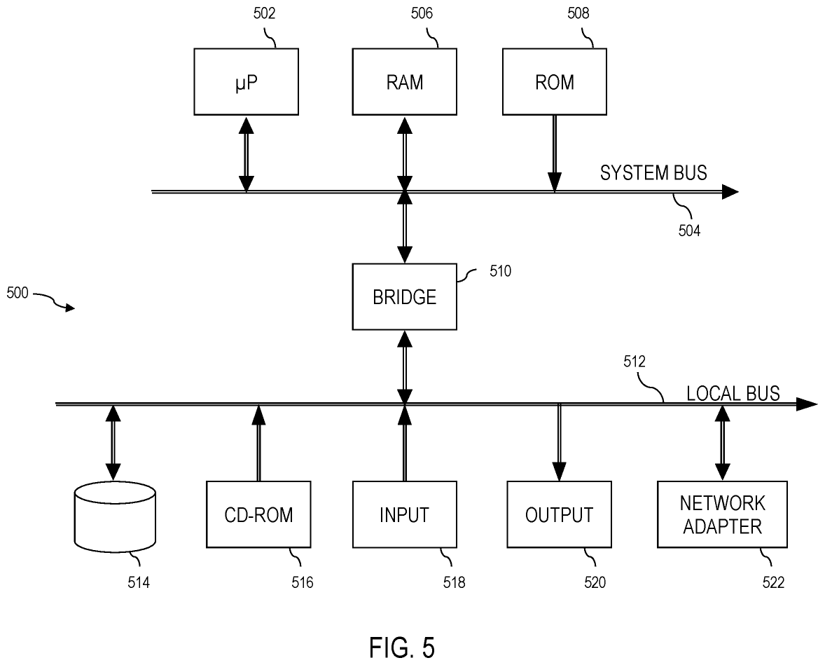

Referring to FIG. 5, a block diagram of a hardware data processing system is depicted in accordance with the present disclosure. Data processing system 500 may comprise a symmetric multiprocessor (SMP) system or other configuration including a plurality of processors 502 connected to system bus 504. Alternatively, a single processor 502 may be employed. Also connected to the system bus 504 is local memory, e.g., RAM 506 and/or ROM 508. An I/O bus bridge 510 interfaces the system bus 504 to an I/O bus 512. The I/O bus 512 is utilized to support one or more buses and corresponding devices, such as storage 514, removable media storage 516, input devices 518, output devices 520, network adapters 522, other devices, combinations thereof, etc. For instance, a network adapter 522 can be used to enable the data processing system 500 to communicate with other data processing systems or remote printers or storage devices through intervening private or public networks.

The memory 506, 508, storage 514, removable media storage 516, or combinations thereof can be used to store program code that is executed by the processor(s) 502 to implement any aspect of the present disclosure described and illustrated in the preceding figures.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A process for performing an action within a machine-generated big data environment, the process comprising:
monitoring, with a first alert, a data repository of machine-generated logs for a first designated change in the machine-generated logs;
performing a first search within the data repository based on the first designated change in the machine-generated logs;
creating and writing a first object to the data repository based on a result of the first search;
monitoring, with a second alert, the data repository of machine-generated logs for a second designated change in the machine-generated logs, wherein the second designated change in the machine-generated logs corresponds to the first object;
performing a second search within the data repository based on the second designated change in the machine-generated logs; and
performing a predetermined action based on the second search.

2. The process of claim 1, wherein creating and writing a first object to the data repository comprises writing the first object including a parameter for the second search to the data repository.

3. The process of claim 2, wherein performing a second search within the data repository comprises performing the second search using the parameter of the object written to the data repository.

4. The process of claim 3, wherein performing a predetermined action based on the second search comprises performing the predetermined action using the parameter of the object written to the data repository.

5. The process of claim 1, wherein creating and writing a first object to the data repository comprises creating and writing a JavaScript Object Notation (JSON) object to the data repository.

6. The process of claim 1, wherein monitoring a data repository of machine-generated logs comprises monitoring an unstructured data repository of machine-generated logs.

7. The process of claim 1, wherein creating and writing a first object to the data repository comprises creating and writing the object to a selected subset of the machine-generated logs.

8. The process of claim 1, wherein performing a predetermined action comprises invoking an external script.

9. The process of claim 8, wherein invoking an external script comprises invoking the external script to make a call on an application programming interface to retrieve data from an external program.

10. The process of claim 1 further comprising displaying the object written to the data repository based on results of the first search.

11. The process of claim 1 further comprising:
monitoring, with a third alert, the data repository of machine-generated logs for the second designated change in the machine-generated logs, wherein the second designated change in the machine-generated logs corresponds to the object written to the data repository based on the results of the first search;
performing a third search within the data repository based on the second designated change in the machine-generated logs; and
performing a second predetermined action based on the third search.

12. The process of claim 1, wherein:
performing a second predetermined action comprises writing a second object to the data repository based on results of the second search; and
the process further comprises:
monitoring, with a third alert, the data repository of machine-generated logs for a third designated change in the machine-generated logs, wherein the third designated change in the machine-generated logs corresponds to the second object written to the data repository based on the results of the second search;
performing a third search within the data repository based on the third designated change in the machine-generated logs; and
performing a second predetermined action based on the third search.

13. A process for verifying a device on a network, the process comprising:
consolidating multiple system logs into a known-devices system log in a data repository;
monitoring the data repository for an event that signifies a new device has accessed a network;
searching, if the event that signifies a new device has accessed a network occurs, the known-devices system log to determine if an identity of the new device is present in the known-devices system log;
writing, if the identity of the new device is not present in the known-devices system log, a locally-not-found object to the data repository, wherein the object includes the identity of the new device;
monitoring data repository for the locally-not-found object;
retrieving, if the locally-not-found object is added to the data repository, the identity of the new device from the locally-not-found object;
invoking, if the locally-not-found object is added to the data repository, an external script that uses an application programming interface (API) of an external application to determine if the identity of the new device is known to the external application;
writing, if the identity of the new device is not known to the external application, an externally-not-known object to the data repository;
monitoring the data repository for the externally-not-known object; and
performing a predetermined action based on the externally-not-known object.
